(19) United States
(12) Patent Application Publication
(10) Pub. No.: US 2014/0199220 A1
(43) Pub. Date: Jul. 17, 2014

(54) THERMAL DESTRUCTION OF NITROSAMINE IN CO2 CAPTURE

(71) Applicants: Gary ROCHELLE, Austin, TX (US); Mandana ASHOURIPASHAKI, Austin, TX (US); Alexander K. VOICE, Okemos, MI (US); Omkar NAMJOSHI, Baton Rouge, LA (US); Steven FULK, Allen, TX (US)

(72) Inventors: Gary ROCHELLE, Austin, TX (US); Mandana ASHOURIPASHAKI, Austin, TX (US); Alexander K. VOICE, Okemos, MI (US); Omkar NAMJOSHI, Baton Rouge, LA (US); Steven FULK, Allen, TX (US)

(21) Appl. No.: 13/740,874

(22) Filed: Jan. 14, 2013

(51) Int. Cl. B01D 53/62

(52) U.S. Cl. CPC B01D 53/62
USPC 423/228; 423/210

(57) ABSTRACT

Methods related to the removal of acidic gas are provided. In particular, the present disclosure relates to methods for the removal of acidic gas from a gas mixture, wherein said methods minimize the accumulated concentration of nitrosamines.

### CROSS-REFERENCE TO RELATED APPLICATIONS

This application claims priority to U.S. Provisional Patent Application Ser. No. 61/585,865 filed Jan. 12, 2012, which is incorporated herein by reference.

### BACKGROUND

As concerns of global climate changes spark initiatives to reduce carbon dioxide emissions, its economic removal from gas streams is becoming increasingly important. Removal by absorption/stripping is a commercially promising technology, as it is well suited to sequester carbon dioxide (CO₂). Such carbon dioxide emissions may be produced by a variety of different processes, such as the gas stream produced by coal-fired power plants. The removal of CO₂ can be an expensive process, potentially increasing the cost of electricity by 50% or more. Therefore, technology improvements to reduce the costs associated with the removal of CO₂ are highly desirable.

The use of absorption and stripping processes with aqueous solvents such as alkanolamines and promoted potassium carbonate is a known, effective technology for the removal and capture of CO₂ from flue gas, natural gas, hydrogen, synthesis gas, and other gases. U.S. Pat. Nos. 4,477,419 and 4,152,217, each of which is incorporated herein by reference, describe aspects of this technology. The first generation of technology relating to alkanolamine absorption/stripping uses aqueous solutions of monoethanolamine (MEA). Advances in this technology have provided other alkanolamine solvents for CO₂ treating in various industries. Monoethanolamine (MEA), diethanolamine (DEA), and the hindered amine AMP are used alone in an aqueous solution. Typical solvent blends include a methyldiethanolamine (MDEA) solution promoted by piperazine or other secondary amines. Also, potassium carbonate solvents are commonly promoted by DEA or other reactive amines.

Gas absorption is a process in which soluble components of a gas mixture are dissolved in a liquid. Stripping is essentially the inverse of absorption, as it involves the transfer of volatile components from a liquid mixture into a gas. In a typical CO₂ removal process, absorption is used to remove CO₂ from a combustion gas, and stripping is subsequently used to regenerate the solvent and capture the CO₂ contained in the solvent. Once CO₂ is removed from combustion gases and other gases, it can be captured and compressed for use in a number of applications, including sequestration, production of methanol, and tertiary oil recovery.

A conventional method of using absorption/stripping processes to remove CO₂ from gaseous streams is described in U.S. Pat. No. 4,384,875, which is incorporated herein by reference. In the absorption stage, the gas to be treated, containing the CO₂ to be removed, is placed in contact, in an absorption column, with the chosen absorbent under conditions of pressure and temperature such that the absorbent solution removes virtually all the CO₂. The purified gas emerges at the top of the absorption column and, if necessary, it is then directed towards a scrubber employing sodium hydroxide, in which the last traces of CO₂ are removed. At the bottom of the absorption column, the absorbent solution containing CO₂ (also called “rich solvent”) is drawn off and subjected to a stripping process to free it of the CO₂ and regenerate its absorbent properties. Other methods of using absorption/stripping process to remove CO₂ from gaseous stream are described in U.S. Patent Application Publication No. 2011/0171093 and U.S. Pat. No. 7,938,887, the entireties of which are hereby incorporated by reference.

Nitrosamines are often produced in conventional CO₂ removal processes that utilize secondary amines. As certain nitrosamines are suspected carcinogens, CO₂ removal processes which minimize the accumulated concentration of nitrosamines are desirable.

### SUMMARY

The present disclosure generally relates to the removal of acidic gases, including carbon dioxide and hydrogen sulfide, from flue gas or other gases through aqueous absorption and stripping processes. More particularly, in some embodiments, the present disclosure relates to methods for the removal of acidic gas from a gas mixture, wherein said methods minimize the accumulated concentration of nitrosamines.

In one embodiment, the present disclosure provides a method comprising contacting an acidic gas with an aqueous amine solvent in an absorber or a stripper, wherein the absorber or stripper operates at a lower steady-state concentration of nitrosamine.

In one embodiment, the present disclosure provides a method comprising contacting an acidic gas with an aqueous amine solvent in an absorber; flowing the solvent to a stripper; extracting all or a portion of the solvent from the stripper and holding the extracted solvent at a temperature greater than the operating temperature of the stripper for a period of time sufficient to thermally decompose nitrosamine present in the extracted solvent.

The features and advantages of the present invention will be readily apparent to those skilled in the art. While numerous changes may be made by those skilled in the art, such changes are within the spirit of the invention.

### DRAWINGS

FIG. 1 is a chart depicting the degradation of piperazine over time.

FIG. 2 is a graph the degradation rate constant for MNPZ.

FIG. 3 is a graph depicting the degradation rate constant for piperazine.

FIG. 4 shows the temperature dependence of k_{Decomp} under the following conditions: 8 m PZ, 0.3 CO₂ loading, 50 mmol/kg NaNO₂

FIG. 5 shows k_{Decomp} dependence on stainless steel ions under condition: 8 m PZ, 0.3 CO₂ loading, 50 mmol/kg NaNO₂

FIG. 6 shows k_{Decomp} dependence on PZ concentration at 0.3 CO₂ loading

FIG. 7 shows a schematic of MNPZ formation and decomposition in amine scrubbing.

FIG. 8 shows k_{g}′ of NO₂ in 8 m PZ compared to CO₂ k_{g}′

FIG. 9 shows mechanism for PZ nitrosation.

FIG. 10 shows temperature dependence of MNPZ nitrosation under conditions: 0.1-8 m PZ, 0.1-0.4 CO₂ loading, pH controlled with phosphate buffer

FIG. 11 shows DNPZ yield under the following conditions: 8 m PZ, 0.3 CO₂ loading, 150° C., 1 hour.

FIG. 12 shows nitrite and nitroso-PZ streams in amine scrubbing.

FIG. 13 shows comparison of pilot plant MNPZ and model.

FIG. 14 shows DNPZ elution time and peak shape using HPLC.

FIG. 15 shows DNPZ Quantification using HPLC.

The patent or application file contains at least one drawing executed in color. Copies of this patent or patent application publication with color drawing(s) will be provided by the Office upon request and payment of the necessary fee.

While the present disclosure is susceptible to various modifications and alternative forms, specific example embodiments have been shown in the figures and are described in more detail below. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure generally relates to the removal of acidic gases, including carbon dioxide and hydrogen sulfide, from flue gas or other gases through aqueous absorption and stripping processes. More particularly, in some embodiments, the present disclosure relates to methods for the removal of acidic gas from a gas mixture, wherein said methods minimize the accumulated concentration of nitrosamines.

While there are various technologies to reduce CO₂ emissions from modern power plants, amine scrubbing is currently the only viable technology for reducing CO₂ emissions in conventional coal-fired power plants. Amine scrubbing uses an aqueous solvent to absorb CO₂ from the flue gas. The solvent is then heated in the stripper to desorb CO₂. The regenerated solvent recycles back to the absorber, and the desorbed CO₂ is pressurized for sequestration.

Amine scrubbing is a an important technology for capture of CO₂ from coal-fired power plants, fossil fuel combustion, and other gases that contain NO_{R}. Some portion of the NO_{R} in these gases may comprise NO₂. Many of these processes, some of which are described in U.S. Patent Application Publication No. 2011/0171093 (incorporated herein by reference), use secondary amines such as piperazine, 2-methylpiperazine, hydroxyethylpiperazine, and methylmonoethanolamine in the capture of CO₂.

NO₂ may be effectively absorbed by reaction with sulfite and with secondary and tertiary amines. While not wishing to be limited to theory, it has been suggested that the sulfite reacts with NO₂ to produce sulfite radical and nitrite as follows:

SO₃⁻+NO₂═SO₃⁻+NO₂⁻.

The reaction with secondary or tertiary amines is believed to be as follows:

R₃N+NO₂═R₃N⁺+NO₂⁻.

Piperazine (PZ) and PZ blends have recently been proposed as alternative solvents to the first generation monoethanolamine (MEA) solvent due to their higher working capacity, faster absorption kinetics, and greater resistance to thermal degradation. However, PZ has two secondary amine groups with no stearic hindrance, so it can be nitrosated to form n-nitrosopiperazine (MNPZ) and dinitrosopiperazine (DNPZ), two relatively stable nitrosamines. In amine scrubbing with PZ, NO₂ from the flue gas will absorb as nitrite (NO₂) and then react with PZ to form MNPZ and trace amounts of DNPZ. Over 80% of nitrosamines are carcinogenic, and MNPZ and DNPZ in particular have a TD50 of 8.7 and 3.6 mg/kg body weight/day, respectively. The Norwegian Climate and Pollution Agency has directly addressed nitrosamines in amine scrubbing, restricting total nitrosamine and nitramine levels to 0.3 ng/m³ in air and 4 ng/L in water. Since MNPZ and DNPZ are carcinogenic and restricted chemicals, it is necessary to properly characterize and then minimize their concentrations in amine scrubbing before adopting the technology for carbon capture and storage.

As mentioned above, nitrites may react with secondary amines such as piperazine at elevated temperatures to produce nitrosamines. Experiments have been performed to measure the production of N-nitrosopiperazine by the reaction of piperazine and nitrite at 100° C. Similar experiments have been performed to measure the production of N-nitrosopiperzine at temperatures from 60° C. to 150° C. The measured rate of nitrite disappearance in piperazine solutions is first order in nitrite and first order in total piperazine as given by the following equations:

d[NO₂⁻]/dt=k_{NO2}[NO₂⁻][Pz]_{t.4}

k₂=0.0463exp(15700*(1/333−1/T))

where T is temperature in Kelvin and k₂ is in units of kg/mol-day.

Nitrosamines are an undesirable degradation product because it is believed to be a carcinogen. Accordingly, it is desirable to prevent the release of nitrosamines into the atmosphere as a gas or in a solvent spill.

Previous work has shown that MNPZ can be reduced by photolytic decomposition or by catalytic hydrogenation. Photolytic decomposition works best for atmospheric nitrosamines where the nitrosamine concentration is low, there is minimal background absorbance, and the sun provides a source of UV light. Catalytic hydrogenation is currently being developed for wastewater treatment where nitrosamine concentration is also low, the solution is non-corrosive, and the catalyst can be reduced. Both photolytic decomposition and catalytic hydrogenation would be hard to implement in an amine scrubbing system where the concentration of nitrosamine is relatively high, the solvent is corrosive, and there is no free source of UV light.

Thermal decomposition is a simple, previously unexplored approach to control nitrosamine concentration. MNPZ thermal decomposition occurs at 100° C. and above, so it is not feasible at the ambient temperatures in water treatment or atmospheric decomposition. However, MNPZ will thermally decompose under the stripper conditions found in an amine scrubber, which makes thermal decomposition the ideal method for nitrosamine control in amine scrubbing. It has also been discovered that the accumulated concentration of nitrosamine can be minimized by designing and operating the CO₂ capture system with additional solvent hold up at elevated temperatures to allow for thermal degradation.

In one embodiment, the disclosure provides a method comprising contacting an acidic gas with an aqueous amine solvent in an absorber or a stripper. U.S. Patent Application Publication No. 2011/0171093, which is incorporated by reference, also methods of contacting an acidic gas with an aqueous amine solvent. In certain embodiments, the processes in these methods may be operated with a lower steady-state concentration of nitrosamines. In certain embodiments, these processes may be operated by providing an additional inventory of solvent to the stripper or absorber. The additional inventory of solvent may be added as the rich stream or as the lean stream. In certain embodiments, the additional volume of solvent may be added at a temperature in the range of from about 90° C. to 180° C. More particularly, in certain embodiments, the additional volume of solvent may be added at a temperature in the range of from about 90° C. to 100° C., in certain embodiments, from about 100° C. to 110° C., in certain embodiments, from about 110° C. to about 120° C., in certain embodiments, from about 120° C. to about 130° C., in certain embodiments, from about 130° C. to about 140° C., in certain embodiments, from about 140° C. to about 150° C., in certain embodiments, from about 150° C. to about 160° C., in certain embodiments, from about 160° C. to about 170° C., and in certain embodiments, from about 165° C. to about 180° C.

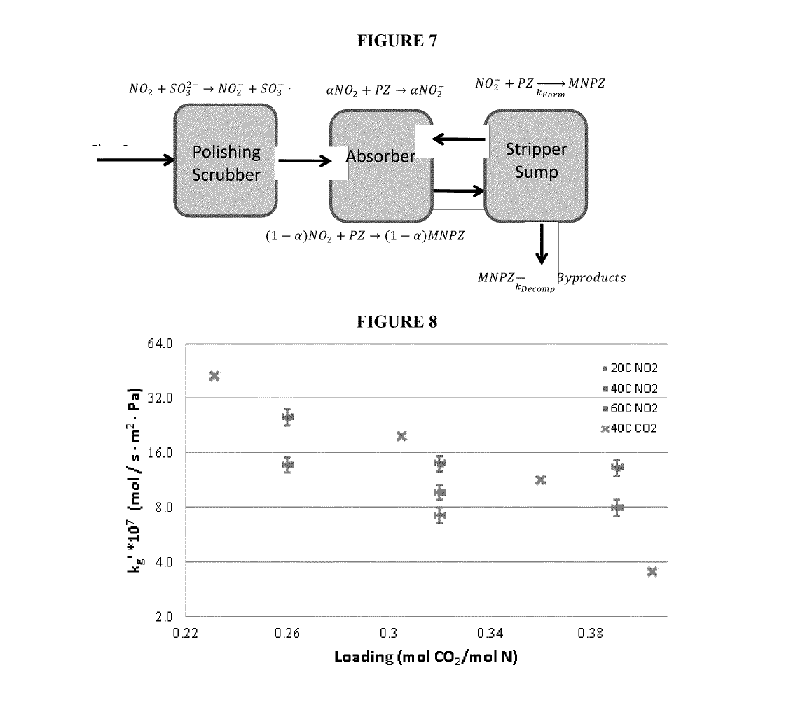

FIG. 7 gives a proposed sequence of processes that determine MNPZ accumulation. MNPZ formation can be traced back to the nitrogen dioxide (NO₂) in the flue gas. Flue gas containing NOₓ enters a polishing scrubber where some of the NO₂ can be removed via reaction with sulfite. The remaining NO₂ then enters the absorber where a fraction of it can absorb into the PZ solution as nitrite or undergo a 2-phase reaction with PZ to directly form MNPZ. The absorbed nitrite will then travel to the stripper where it nitrosates PZ to form MNPZ. PZ nitrosation has previously been observed under acidic conditions or under basic conditions in the presence of formaldehyde. Sun et. al have shown that absorbed CO₂ can also theoretically catalyze nitrosamine formation in a PZ solvent. Oxidative degradation products may also act as nitrosating agents for amine scrubbing, but flue gas NO₂ is likely to be a more important precursor to nitrosamine formation in amine scrubbing. Once in the stripper, MNPZ will thermally decompose to not yet identified byproducts. MNPZ formation from flue gas NO₂ and MNPZ thermal decomposition will balance out to eventually give a stable steady-state concentration of MNPZ. Nitrite scavenging will not necessarily be a viable strategy to inhibit nitrosamine formation since nitrosation might occur directly in the absorber as well as in the stripper.

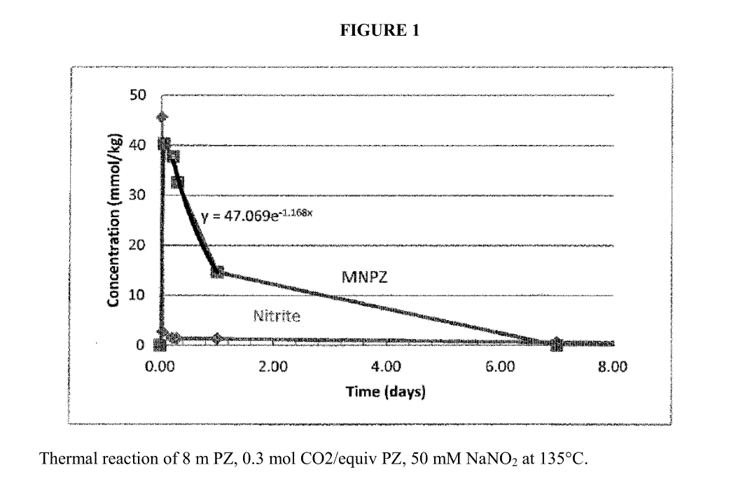

Nitrosopiperazine has been formed and decomposed in a series of experiments at 100° C. to 150° C. FIG. 1 illustrates the results of such experiments. Solutions containing piperazine, CO₂, and sodium nitrite were heated for variable times. The solution was analyzed by HPLC for mononitrosopiperazine (MNPZ). FIG. 1 shows the decomposition results of 8 m piperazine, 0.3 mol CO₂/equiv PZ, and 50 mM NaNO₂ at 150° C. The nitrite disappeared in less than 1 hour and was converted to 40 mM MNPZ. The MNPZ also decomposed. The first order rate constant, k₁ for MNPZ decomposition was 2.4 day⁻¹ and the following equation governed the reaction

d[MNPZ]/dt=k_{MNPZ}[MNPZ][PZ].

Table 1 gives the second order rate constant for MNPZ for five experiments.

TABLE 1
Decomposition Rates for MNPZ

| T(° C.) | PZ (m) | ldg (mol CO₂) | k₁ (day⁻¹) | k_{MNPZ} (m⁻¹) |
|---|---|---|---|---|
| 150 | 8 | 0.3 | 2.405 | 0.0300625 |
| 135 | 8 | 0.3 | 1.17 | 0.14625 |
| 100 | 8 | 0.3 | 0.058 | 0.00725 |
| 150 | 2 | 0.3 | 1.04 | 0.52 |
| 135 | 2 | 0.3 | 0.22 | 0.11 |

The MNPZ decomposition rate appears to be first order in MNPZ and in total piperazine as given by the following equations:

d[MNPZ]/dt=k_{MNPZ}[MNPZ][PZ]_{T}

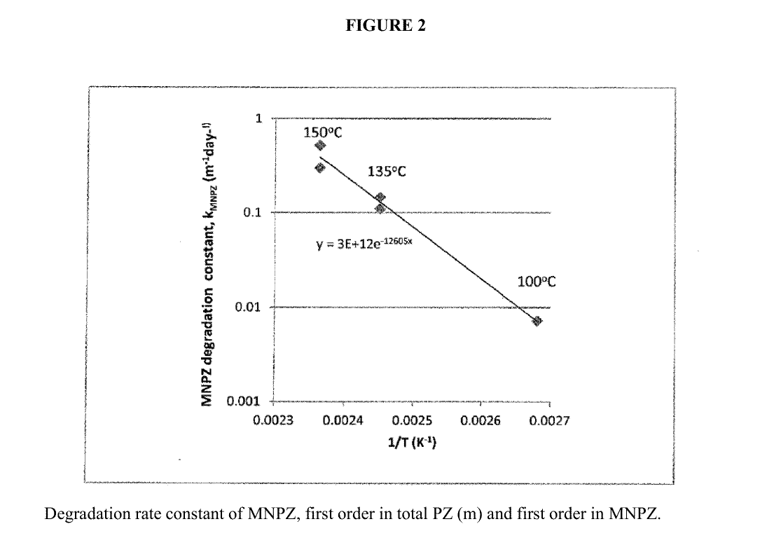

FIG. 2 illustrates the correlation between kMNPZ with temperature, which is represented by the following equation

k_{MNPZ}=3E+12e^{-12605/T}.

The temperature dependence corresponds to an activation energy of 105 kJ/mol.

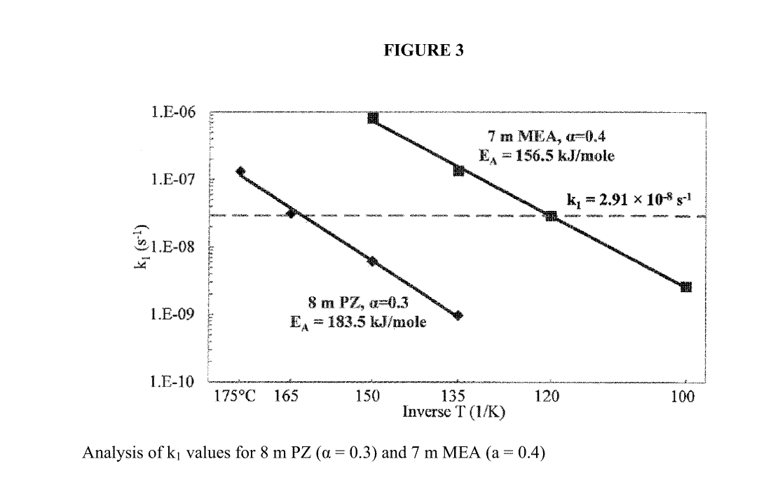

piperazine also degrades at elevated temperatures. The first order degradation rate constant for piperazine is shown in FIG. 3. The activation energy for PZ thermal degradation is 184 kJ/mol.

Therefore, in CO₂ removal processes, if additional liquid volume is added at the elevated temperature of the stripper, the nitrosamine concentration may be reduced to a manageable level. However there may be tradeoff with the thermal degradation of PZ.

In certain embodiments, the nitrosamine concentration may be reduced by extracting all or a portion of solvent from the stripper and heating the extracted solvent to a temperature greater than the operating temperature of the stripper for a period of time sufficient to thermally decompose the nitrosamines present in the extracted solvent. For example, the stripper may be operating at a temperature in the range of from about 100° C. to about 160° C. In certain embodiments, the stripper may be operating at a temperature in the range of from about 140° C. to about 150° C. In certain embodiments, the stripper may be operating at about 150° C. All or a portion of the solvent present in the stripper may be extracted from the stripper and heated to a temperature in the range of from about 160° C. to about 180° C. The extracted solvent may be held at a temperature within that range for a period of time sufficient to degrade the nitrosamines present in the extracted solvent. The period of time sufficient to degrade the nitrosamines is dependent upon the moles of CO₂ removed from the gas mixture being treated and the flow rate of the system. The period of time at which the extracted solvent is held at a temperature greater than the operating temperature of the stripper may be expressed as the range of from about 1 L of solvent/(mol C0₂ removed/min) to about 20 L solvent/(mol CO₂ removed/minute).

In certain embodiments, the extracted solvent may be held at an elevated temperature for a period of time sufficient to result in a nitrosamine concentration in the extracted solvent that is undetectable using current methods. In certain other embodiments, the extracted solvent may be held at an elevated temperature for a period of time sufficient to result in a nitrosamine concentration in the range of from about 0.1 to about 2 millimoles/liter. In certain other embodiments, the extracted solvent may be held at an elevated temperature for a period of time sufficient to result in a nitrosamine concentration in the extracted solvent that complies with the standards set forth by applicable government and/or regulatory agencies. Following decomposition of the nitrosamines present in the extracted solvent to the desired amount, the solvent may be returned through the cross-exchanger to the stripper and recirculated to the absorber.

While the present disclosure primarily discusses removal of CO₂, any acidic gas capable of removal by the methods of the present invention is contemplated by the present disclosure. Such acidic gases may include, but are not limited to, hydrogen sulfide (H₂S) or carbonyl sulfide (COS), CS₂, and mercaptans. Similarly, amines may be recovered following absorption of acidic gas. In certain embodiments, such recovery may occur through an evaporation process using a thermal reclaimer.

The gas mixture may be any gas mixture comprising an acid gas for which acid gas removal is desired and which is compatible with (i.e., will not be adversely affected by, or will not adversely react with) the methods of the present disclosure. In certain embodiments, the gas mixture may comprise any gas mixture produced as the byproduct of a chemical process. Suitable gas mixtures may comprise one or more of flue gas, natural gas, hydrogen gas and other gases.

### EXAMPLES

### Example 1

### No Additional Liquid Volume

10% CO₂ is removed from flue gas by contact with a lean solution of 8 m piperazine containing 0.3 mol CO₂/mol PZ. The CO₂ in the solvent is increased by 1 mol/liter of solvent. 1 ppm of NO₂ is absorbed from the flue gas and converted to MNPZ in the absorber and stripper. The rich solvent is regenerated in a simple stripper operating with a reboiler at 150° C. The residence time of the solvent in the reboiler and bottom of the stripper at 150° C. is minimized by equipment design to minimize the thermal degradation of the piperazine to a value of about 6 minutes. The residence time of solvent in the somewhat lower temperature of the stripper, 130° C. to 150° C., is 2 minutes. The lean solution is stored for 30 minutes at 40° C. MNPZ decomposes in the reboiler and bottom of the stripper with a rate constant, k_{MNPZ}, of 0.023 m⁻¹day⁻¹. Therefore the steady-state concentration of MNPZ is given by the following equation:

$$[ MNPZ ] = \frac{1 e - 6 mol MNPZ}{0.1 mol CO 2} \frac{1 mol CO 2}{liter solvent} \frac{day m}{0.3 * 8 m PZ} \frac{ }{6 min} \frac{60 * 24 min}{day} = 0.001 mol \text{/} kg soln$$

The thermal degradation of PZ primarily occurs at 150° C. in the bottom of the stripper. The amount of thermal degradation is governed by the following equation

PZ loss=2e⁻⁵ mol/mol CO₂ removed.

### Example 2

### Additional Liquid Inventory at Reboiler T

The solvent inventory at 150° C. is increased to 30 minutes by increasing the volume of the stripper sump or by adding an additional pressure vessel at the bottom of the stripper to hold hot lean solution. The stripper could be used to replace the lean storage tank and operated with variable level for ease of process control. The steady state concentration of MNPZ would decrease by factor of 5 to 0.0002 mol/liter solvent. The thermal degradation rate of piperazine would increase to 15e-8 mol/mol CO₂ removed.

### Example 3

### Additional Lean Solvent Inventory at 110° C.

Starting with the flowsheet of example 1, the lean storage tank will be moved and the cross exchanger is split into two units so that the lean inventory is stored for 30 min at 110° C. rather than 40° C. At 110° C. the rate constant for MNPZ degradation is 0.02 m⁻¹ day⁻¹. Including the decomposition at 110° C. and 150° C., the steady state MNPZ is given by 0.00075 mol/kg soln.

The additional time at 110° C. will increase the degradation of piperazine in a similar fashion to give a total degradation of 2e-5 mol/mol CO₂ removed. Because the activation energy of piperazine degradation is greater that of MNPZ decomposition, residence time at 110° C. gives relatively more MNPZ decomposition than PZ degradation.

### Example 4

### Additional Rich Solvent Inventory at 140° C.

Starting with the flowsheet of example 1, 30 min of additional rich solvent inventory can be added in the hot feed to the stripper. This additional pressure vessel can be equipped with a vapor product to reduce the amount of vapor produced in the stripper. The estimated MNPZ steady-state concentration is 2.3e-4 mol/kg soln. The PZ degradation is 4.9e-5 mol/mol CO₂ removed.

### Example 5

### Additional Solvent Inventory at 170 C.

Solvent is extracted from the stripper, heated in a cross-exchanger, and then heated to 17° C. by an additional steam heater. After being held for 6 min at 170° C., the solvent is returned through the cross-exchanger to the stripper. Excess heat not recovered by the cross-exchanger is returned to the stripper as the hot solvent flashes. A significant amount of MNPZ decomposition occurs with very little additional inventory, but with relatively more PZ degradation. The steady-state MNPZ is 2.3e-4 mol/kg soln. The PZ degradation is 0.0003 mol/mol CO₂ removed because of the elevated temperature.

### Example 6

### Thermal Decomposition of N-Nitrosopiperazine

Sample Preparation

Solutions of PZ and CO₂ were prepared with 0.2 m⁻⁸ m PZ and 0-0.3 mol CO₂/mol N. In solutions with 0 loading, sulfuric acid (H₂SO₄) was added to control pH. The prepared solution was spiked gravimetrically with a maximum of 50 mmol/kg solution of sodium nitrite (NaNO₂) or MNPZ standard and then immediately pipetted into ⅜-inch or ½-inch Swagelok thermal cylinders made from 316L stainless steel. The cylinders were placed in vented convection ovens at 100° C. to 165° C. Cylinders were removed at set intervals until 90% of the MNPZ had decomposed. The samples were quenched in a water bath and then stored in amber vials at room temperature. Samples were analyzed within a week to avoid any UV degradation of the nitrosamine. Table 2 shows the chemicals used in the experiments conducted in this Example.

TABLE 2
Chemicals Used

| | Purity | |
|---|---|---|
| Chemical | (wt %) | Supplier |
| Anhydrous Piperazine | 99 | Sigma-Aldrich |
| Carbon Dioxide | 99.99 | Matheson Tri-Gas |
| Sodium Nitrite | 98.5 | Acros organics |
| Sulfuric Acid | 98 | Acros organics |
| Ferrous (II) Sulfate | 99 | Ricca |
| Heptahydrate | | |
| Nickel Sulfate Hexahydrate | 98 | Alfa Aesar |
| Chromic (III) Sulfate Hydrate | 99 | Pfaltz & Bauer |
| N-nitrosopiperazine | 98 | Toronto Research Chemicals |

Sample Analysis

Samples were diluted in water by a factor between 20 and 150 and analyzed for MNPZ and nitrite (NO₂⁻). Both MNPZ and nitrite were analyzed using reverse-phase High Performance Liquid Chromatography with a UV detector at 240 nm. The eluents used were 10 mM ammonium carbonate (NH₄)₂CO₃ (pH=9.1) polar phase and acetonitrile (ACN) non-polar phase. The analytical column was Dionex Polar Advantage II, 4×250 mm. The MNPZ eluted at 6.2 minutes with a peak width of 1 minute. Since nitrite is an anion, it eluted in the void space at 2.4 minutes. MNPZ decomposition produces trace byproducts that also elute in the void space, making it impossible to quantify nitrite at very low concentrations. Calibration curves were made with purchased standards; the curves were linear in the calibration range with quantification limits of 0.3 ppm MNPZ and 3 ppm of nitrite.

Kinetics Modeling

MNPZ decomposition was modeled as a pseudo-first order decomposition in MNPZ. Each thermal cylinder represents an individual batch experiment with MNPZ decomposing exponentially. MNPZ decomposition was regressed only after the cylinders reached the target temperature and all of the nitrite had reacted (Equation 1).

$${C}_{MNPZ} = {C}_{{MNPZ}_{o}} * {e}^{- {k}_{Decomp} ( t - {t}_{o} )} \\ For \text{:} \frac{{NO}_{{2}_{to}}^{-}}{{NO}_{{2}_{i}}^{-}} < .01 \qquad ( 1 )$$

The data were regressed with k_{Decomp} and C_{MNPZ0} as free parameters using a JMP nonlinear regression. MNPZ decomposition was first order in MNPZ in every experiment and the relative standard error for k_{Decomp} was less than 5% for almost every experiment.

Results for 21 experiments are presented in the following table:

TABLE 3
Individual Experimental Regression

| | PZ | | Temp. | | k_{Decomp}*10⁶ | Model*10⁶ |
|---|---|---|---|---|---|---|
| Exp # | (m) | Loading | (° C.) | Condition | (s⁻¹) | (s⁻¹) |
| 1 | 8 | 0.3 | 100 | | 0.72 ± 0.02 | 0.76 |
| 2 | 8 | 0.3 | 120 | SS ions | 3.7 ± 0.1 | 3.6 |
| | | | | added | | |
| 3 | 8 | 0.3 | 135 | | 11.1 ± 0.5 | 10.2 |
| 4 | 8 | 0.3 | 150 | SS ions | 26.9 ± 1.6 | 27.4 |
| | | | | added | | |
| 5 | 8 | 0.3 | 165 | | 65.3 ± 0.7 | 68.3 |
| 6 | 8 | 0.34 | 150 | 1/2 in. OD | 28.0 ± 1.8 | x |
| 7 | 8 | 0.34 | 150 | 3/8 in. OD | 31.4 ± 1.5 | x |
| 8 | 8 | 0.34 | 150 | 1/2 in. OD | 32.4 ± 1.3 | x |
| | | | | pack | | |
| 9 | 2 | 0.3 | 135 | | 5.4 ± 0.2 | 5.1 |
| 10 | 4 | 0.3 | 150 | | 22.6 ± 0.2 | 20.0 |
| 11 | 2 | 0.3 | 150 | | 15.4 ± 0.1 | 14.4 |
| 12 | 1 | 0.3 | 150 | | 10.7 ± 0.1 | 10.4 |
| 13 | 0.4 | 0.3 | 150 | | 6.8 ± 0.3 | 6.8 |
| 14 | 0.2 | 0.3 | 150 | | 5.0 ± 0.2 | 4.9 |
| 15 | 2 | 0.3 | 165 | | 28.4 ± 0.8 | 34.2 |
| 16 | 8 | 0.1 | 135 | | 11.9 ± 3.5 | 12.2 |
| 17 | 8 | 0.1 | 150 | | 28.6 ± 0.4 | 26.7 |
| 18 | 8 | 0.1 | 165 | | 55 ± 3.8 | 55.5 |
| 19 | 2 | 0.1 | 135 | | 13.0 ± 0.7 | 12.2 |
| 20 | 2 | 0.1 | 150 | | 23.6 ± 1.3 | 26.7 |
| 21 | 2 | 0.1 | 165 | | 53 ± 2.2 | 55.4 |

Dependence on Temperature

Solutions of 8 m PZ loaded to 0.3 mol CO₂/mol N were heated at 100° C. to 165° C. The rate constant was assumed to follow an empirical Arrhenius model centered at 135° C. given by Equation 2.

$$ln {k}_{Decomp} ( T ) = ln {k}_{Decomp} ( 408 K ) + \frac{Ea}{R} ( \frac{1}{408} - \frac{1}{T} ) \qquad ( 2 )$$

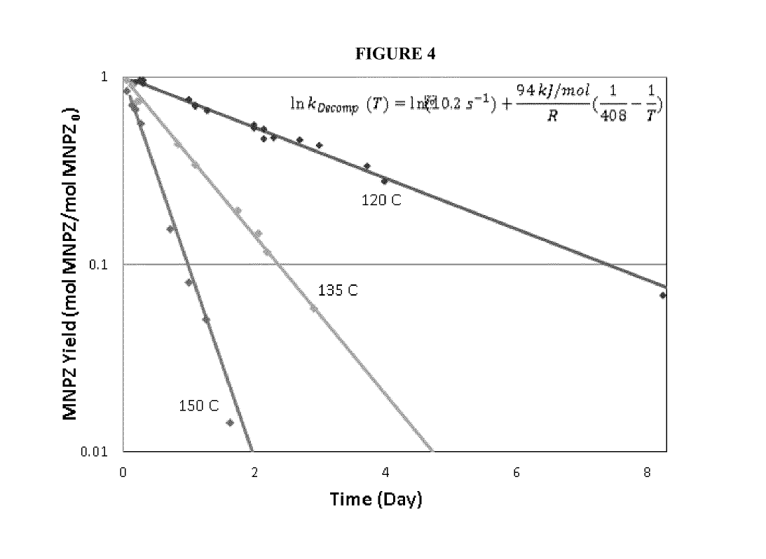

Each experiment was analyzed individually (Table 3: Experiments 1-5), and the decomposition rate constants were regressed using Equation 2. The model fits the data for 8 m PZ at a CO₂ loading of 0.3 with an activation energy of 94±2 kJ/mol and a rate constant at 135° C. of 10.2±0.5*10⁻⁶ s⁻¹ (FIG. 4). The Arrhenius equation was also regressed for 8 m PZ at a loading of 0.1 (Table 3: Experiments 16-18) and the activation energy was 75±6 kJ/mol with a rate constant at 135° C. of 12.2±1.3*10⁻⁶ s⁻¹.

Dependence on Stainless Steel Ions and Stainless Steel Surface Area

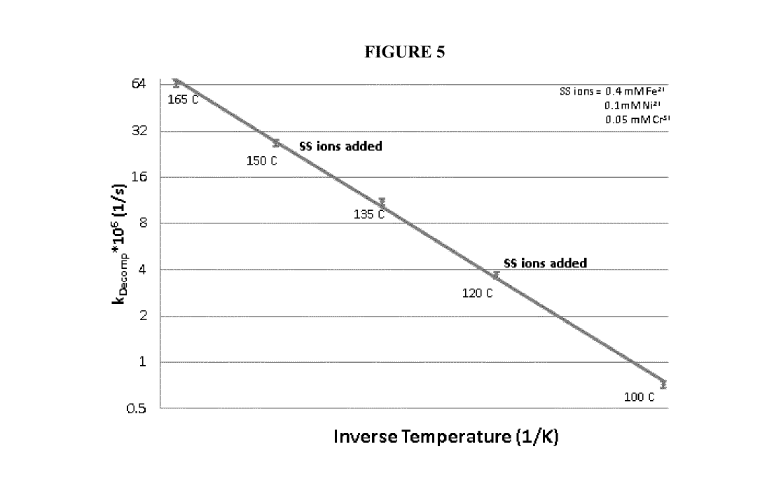

The dependence of k_{Decomp} on stainless steel ions was tested by spiking the solutions for the 120° C. and 150° C. temperature experiments with 0.4 mM Fe²⁺, 0.1 mM Ni²⁺, and 0.05 mM Cr³⁺ (Table 3: Experiments 2 & 4). At this temperature and time there will be minimal corrosion in the cylinders, so the metal ions only come from the added solutions. The Arrhenius model fits the regressed rate constants regardless of whether stainless steel ions were added (FIG. 5). Thus, MNPZ decomposition is not catalyzed by stainless steel ions.

To test for dependence on stainless steel surface area, solutions of 8 m PZ and a CO₂ loading of 0.34 were heated at 150° C. in ½-inch OD cylinders, ⅜ inch OD cylinders, and ½-inch OD cylinders with stainless steel packing. The packing has a surface area of approximately 1200 m²/m³, which roughly quadrupled the surface area available for reaction in the ½-inch cylinders. The decomposition rate constant is not statistically different for the three experiments, so MNPZ decomposition is not catalyzed by the stainless steel surface (Table 3: Experiments 6-8).

Dependence on PZ Concentration and Loading

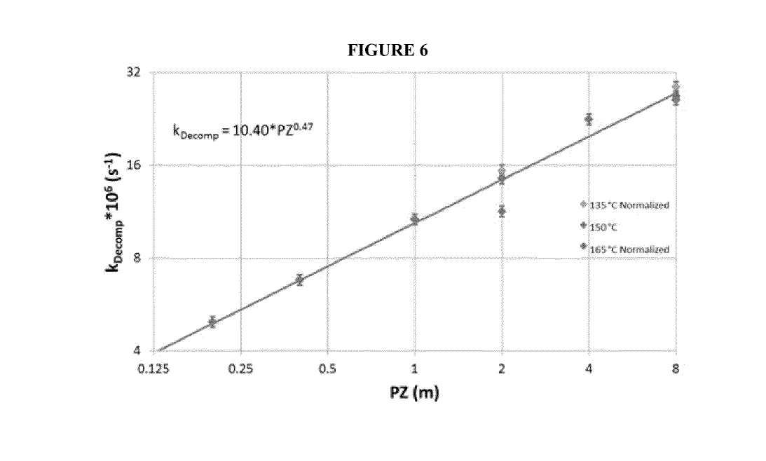

Solutions with PZ varying from 0.2 m to 8 m with a CO₂ loading of 0.3 were heated at 135° C. to 165° C. (Table 3: Experiments 3-5 & 9-15). All decomposition rate constants were then normalized to 150° C. using the Arrhenius model and the kinetics were fit to an empirical power law (FIG. 6). At a loading of 0.3, MNPZ decomposition is roughly half order in PZ concentration. The empirical PZ order cannot be the average of two parallel reaction orders since the power law fits the rate constants at dilute concentrations. A similar experimental design was carried out at a CO₂ loading of 0.1 (Table 3: Experiments 16-21) and the PZ concentration dependence was found to be statistically equivalent to zero. The unusual loading and PZ concentration dependence could be explained by an unknown reactant in equilibrium with PZ and CO₂. However, none of the species in the current PZ model can explain the data. Therefore the equilibrated species is most likely an MNPZ derivative that has not yet been modeled. More data must be collected to fully explain the dependence of MNPZ decomposition on PZ concentration and loading.

Equations 3 & 4 give empirical models for MNPZ decomposition. Since the activation energy and the dependence on PZ concentration are dependent on loading, there is currently no empirical model that fits decomposition kinetics at both loadings.

$$\begin{matrix}{k}_{Decomp} = 12.2 * {10}^{- 6} e \frac{75 kJ \text{/} mol}{R} ( \frac{1}{408} - \frac{1}{T} ) {s}^{- 1} \\ For α = 0.1 & ( 3 ) \\ {k}_{Decomp} = 10.2 * {10}^{- 6} e \frac{94 kJ \text{/} mol}{R} ( \frac{1}{408} - \frac{1}{T} ) * \frac{{C}_{{PZ}^{0.47}}}{8 m} {s}^{- 1} \\ For α = 0.3 & ( 4 )\end{matrix}$$

Thermal decomposition of n-nitrosopiperazine (MNPZ) was measured in 0.2-8 m aqueous piperazine (PZ) loaded with 0.1 to 0.3 mol CO₂/equiv N from 100 to 165° C. In 8 PZ with 0.3 mol CO₂/equiv N, MNPZ thermal decomposition follows Arrhenius temperature dependence with an activation energy of 94 kJ/mol and a rate constant of 10.2*10⁻⁶ s⁻¹ at 135° C. MNPZ decomposition is dependent on PZ concentration and CO₂ loading, but independent of stainless steel ions and stainless steel surface. MNPZ decomposition is first order in MNPZ. The pseudo-first order decomposition rate constant is a function of temperature, loading, and PZ concentration.

### Example 7

### NO₂ Absorption Experimental Method

Mass transfer of NO₂ into the amine solvent was modelled using the rate based equation for NO₂ flux (Equations 1 & 2).

$$\begin{matrix}{N}_{{NO}_{2}} = {K}_{9} * {P}_{{NO}_{2}} = \frac{Δ {NO}_{2}}{A} & ( 1 ) \\ \frac{1}{{K}_{G}} = \frac{1}{{k}_{g}} + \frac{1}{{k}_{g}^{′}} & ( 2 )\end{matrix}$$

The K_{g} for NO₂ absorption was measured for 8 m PZ at 0.2-0.4 mol CO₂/mol alkalinity using a wetted wall column and a method previously developed by Dugas. The k_{g}′ was extracted from K_{g} using correlations for k_{g} specific to the geometry of the wetted wall column; for every experiment, k_{g}′ was the dominant mass transfer coefficient. Conditions for the inlet gas stream are shown below (Table 4). The outlet gas composition was measured using a hot gas FTIR.

TABLE 4
Gas Stream Conditions

| Condition | | Range |
|---|---|---|
| Temperature | (° C.) | 20-60 |
| Pressure | (psig) | 20-40 |
| Flow Rate | (SLPM) | 2 |
| NO₂ | (ppm) | 50-300 |
| CO₂ | (%) | 0-4 |
| N₂ | (%) | 95-99 |

NO₂ Absorption Results

Values for k_{g}′ are plotted as a function of CO₂ loading and temperature in FIG. 8. The k_{g}′ has a slight temperature dependence with an activation energy of 13±5 kJ/mol. There is also a small k_{g}′ dependence on loading, but it is much smaller than the loading dependence seen for CO₂ absorption. The fraction of NO₂ absorbed in the absorber is given by Equations 3 and 4 where N_{OG} is the number of overall gas phase transfer units.

$$\begin{matrix}\frac{{NO}_{{2}_{absorbed}}}{{NO}_{{2}_{Flue}}} = ( 1 - {e}^{- {N}_{OG}} ) & ( 3 ) \\ {N}_{OG} = \frac{{K}_{G} * {A}_{total}}{G} & ( 4 )\end{matrix}$$

NO₂ absorption varies from 91% to 99.9% over the entire range of k_{g}′ measured and at a typical A/G of 3.3*10⁶ s·Pa·m²/mol. Thus for a PZ solvent, it is prudent to assume all of the NO₂ will absorb either as MNPZ or as NO₂.

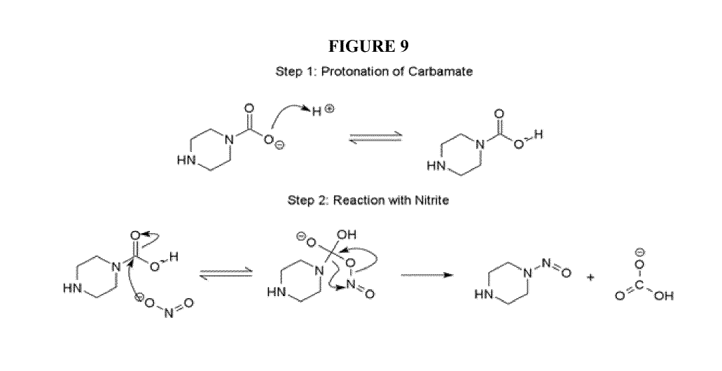

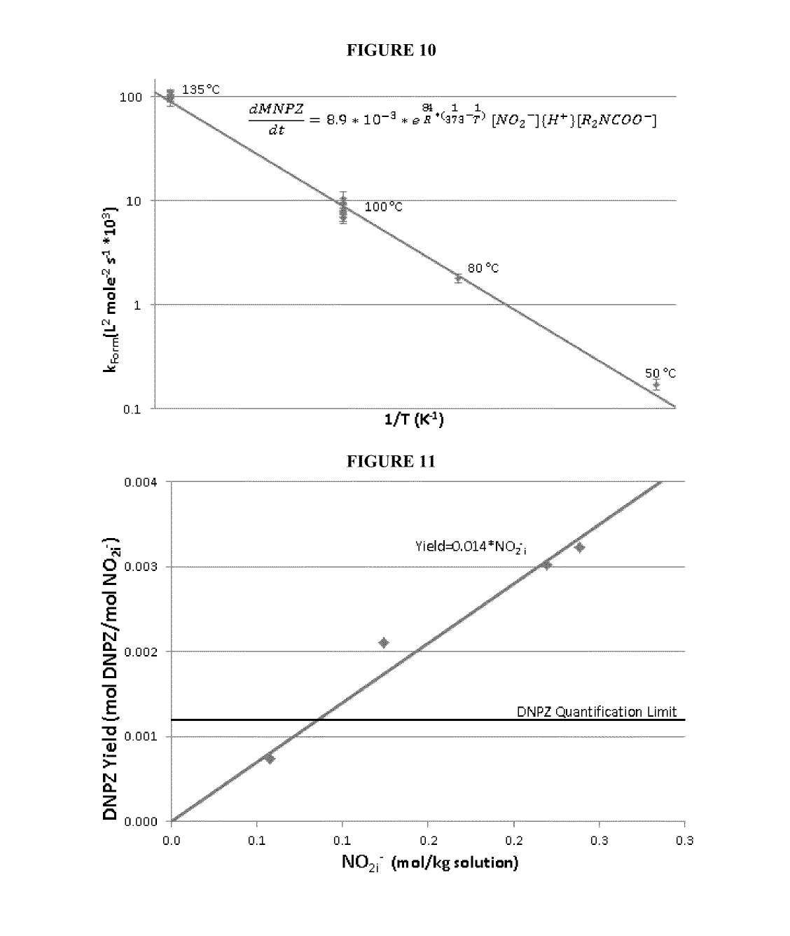

Previous research suggests that up to half of the NO₂ could directly nitrosate PZ from the gas phase; the balance of the NO₂ will absorb as nitrite. The absorbed nitrite will enter the stripper sump where it will rapidly nitrosate piperazine. PZ nitrosation was measured using Swagelok thermal cylinders heated at 50 to 135° C. PZ nitrosation was found to be first order in nitrite over a wide range of temperature and PZ concentration. The pseudo-first order rate constant with respect to nitrite was measured at 0.1-8 m PZ, CO₂ loading varying from 0.1-0.4 mol CO₂/mol alkalinity, and 50-135° C. In a set of experiments, the pH was carefully controlled using a phosphate buffer. Nitrosation was found to be first order in nitrite, carbamated PZ species (PZCOO⁻), and hydronium ions (H⁺) with almost perfect yield. The experimental kinetics can be explained by a mechanism previously suggested in theoretical research on NDMA formation (FIG. 9). The temperature dependence fits an Arrhenius model with an activation energy of 84 kJ/mol and a rate constant of 8.9*10⁻³ M⁻²s⁻¹ at 100° C. (FIG. 10). Error in the rate constant can be attributed to CO₂ speculation into bicarbonate (HCO₃⁻) instead of PZCOO⁻. Nitrite scavenging will not necessarily be a viable strategy to inhibit nitrosamine formation since nitrosation might occur directly in the absorber as well as in the stripper.

Thermal Decomposition of MNPZ

MNPZ thermal decomposition was measured using Swagelok thermal cylinders heated to stripper conditions; under these conditions MNPZ decomposition was found to be first order in MNPZ. The pseudo-first order rate constant was analysed with PZ varying from 0.1-8 m and a CO₂ loading of 0.1 and 0.3. The pseudo-first order rate constant can be modelled within 15% of the experimental results for stripper conditions (Equations 5 & 6). Decomposition is not catalyzed by stainless steel ions or stainless steel surface area.

$$\begin{matrix}{k}_{Decomp} = 10.2 * {10}^{- 6} e \frac{94 kJ \text{/} mol}{R} ( \frac{1}{408} - \frac{1}{T} ) * \frac{{C}_{{PZ}^{0.47}}}{8 m} {s}^{- 1} \\ For α = 0.3 & ( 5 ) \\ {k}_{Decomp} = 12.2 * {10}^{- 6} e \frac{75 kJ \text{/} mol}{R} ( \frac{1}{408} - \frac{1}{T} ) {s}^{- 1} \\ For α = 0.1 & ( 6 )\end{matrix}$$

DNPZ Formation and Decomposition

Experimental Method

A solution of 8 m PZ with 0.3 CO₂ loading was spiked with 50-200 mmol/kg of sodium nitrite (NaNO₂). The solution was loaded into Swagelok thermal cylinders and heated in a vented convection oven for one hour at 150° C. to yield complete conversion of nitrite to nitrosamine. The cylinders were quenched in water and emptied into amber vials to limit further decomposition of the nitrosamine.

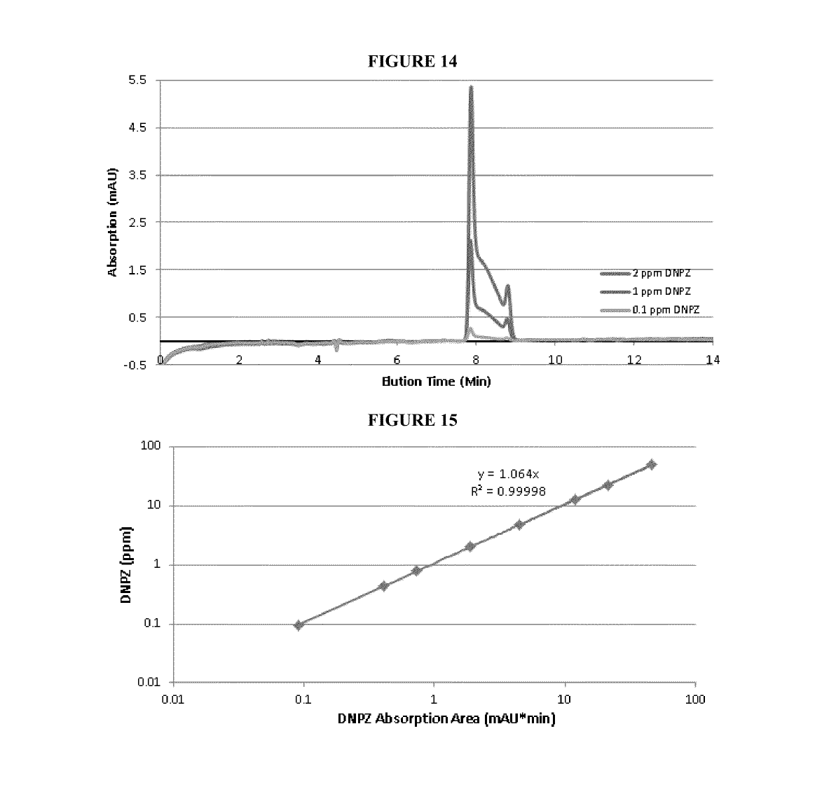

The samples were diluted 40× in water and analyzed for MNPZ and DNPZ using HPLC. The calibration curve for DNPZ was created using a 99% pure DNPZ standard purchased from Toronto Research Chemicals. The HPLC method and column was the same used for previous MNPZ experiments. The column used was Acclaim™ PolarAdvantage II column, 4.6 mm×500 mm. Eluents used were 10 mM ammonium carbonate (pH=9.1) polar phase, Acetonitrile non-polar phase. Eluent Composition was 95% (NH₄)₂CO₃ and 5% ACN from 0-10 min.; 50% (NH₄)₂CO₃ and 50% ACN from 10-14 min. Eluent Flow was 2 mL/min; UV wavelength was 240 nm. DNPZ elutes between 7.6 and 9 minutes and has a unique bimodal shape (FIGS. 14 and 15). The calibration curve was linear in the analyzed region with a quantification limit of 0.4 ppm DNPZ and a detection limit of 0.1 ppm DNPZ.

Kinetics Modeling

DNPZ was hypothesized to form from the nitrosation of the carbamated amine of MNPZ. For a low yield of DNPZ and a reaction time of one hour, the batch rate equations can be modeled as two parallel reactions with no nitrosamine decomposition as shown below. Both k_{MNPZ} and k_{DNPZ} are extremely sensitive to pH.

$$\begin{matrix}PZ + {NO}_{2}^{-} {}_{{k}_{MNPZ}} MNPZ \\ \frac{d MNPZ}{d t} = {k}_{MNPZ} {C}_{{NO}_{2}^{-}} {C}_{{PZCOO}^{-}} & ( 7 ) \\ MNPZ + {NO}_{2}^{-} {}_{{k}_{DNPZ}} DNPZ \\ \frac{d DNPZ}{d t} = {k}_{DNPZ} {C}_{{NO}_{2}^{-}} {C}_{{MNPZCOO}^{-}} & ( 8 )\end{matrix}$$

DNPZ formation is effectively second order in NO₂⁻ with the intermediate MNPZ. The solution to Equation 5 is given below along with the final DNPZ yield after complete nitrosation.

$$\begin{matrix}\frac{{C}_{DNPZ}}{{C}_{{NO}_{2}^{-} i}} = \frac{{k}_{DNPZ}}{2 {k}_{MNPZ} {C}_{{PZCOO}^{-}}} ( 1 + {e}^{- 2 {k}_{{MNPZ}^{t}}} - 2 {e}^{- {k}_{{MNPZ}^{t}}} ) {C}_{{NO}_{2}^{-} i} & ( 9 ) \\ Yield = \frac{{C}_{DNPZ}}{{C}_{{NO}_{2}^{-} i}} = \frac{{k}_{DNPZ}}{2 {k}_{MNPZ}} * \frac{{C}_{{NO}_{2}^{-} i}}{{C}_{{PZCOO}^{-}}} & ( 10 )\end{matrix}$$

DNPZ Formation Results

The yield was plotted against initial NO₂⁻ and was linear with a slope of 0.014 kg solution/mol NO₂⁻ (FIG. 11). In a continuous cycle, the concentration of MNPZ will reach a steady state, and the yield to DNPZ will be a constant dependent on the ratio of k_{DNPZ} to k_{MNPZ}. For 8 m PZ with a 0.3 CO₂ loading, the ratio of k_{DNPZ} to k_{MNPZ} is approximately 0.03*C_{MNPZ}.

DNPZ Decomposition

8 m PZ with 0.3 CO₂ loading was spiked with 5 mmol/kg of DNPZ standard and heated to 150° C. The DNPZ decomposed below the quantification limit within 16 hours with a pseudo-first order rate constant of 90*10⁻⁶ s⁻¹.

Modeling NNO Concentrations in Amine Scrubbing

Model Development

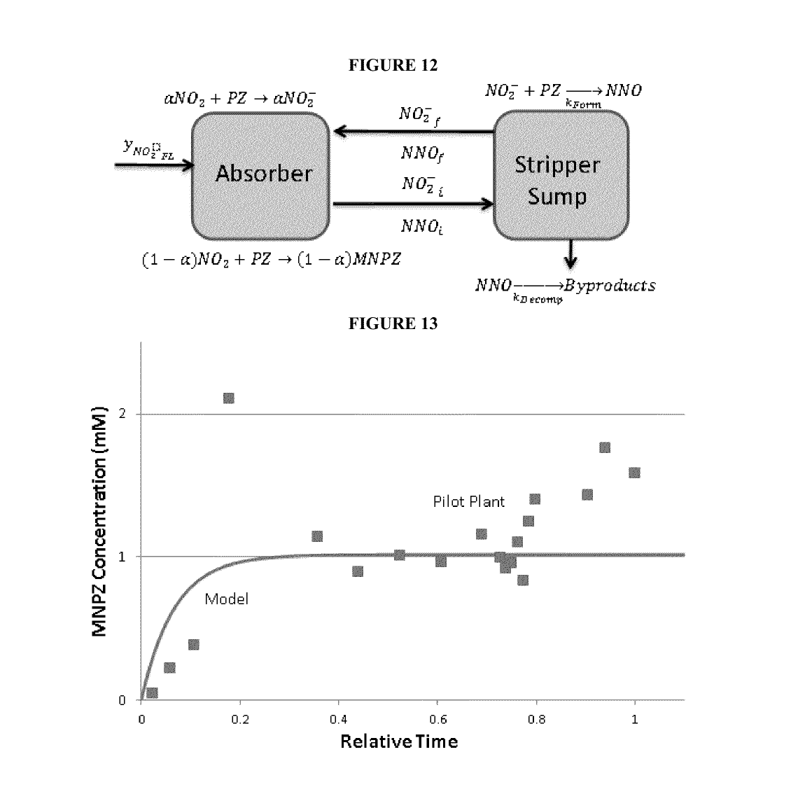

Modeling MNPZ and DNPZ begins with the NO₂ in the flue gas. A fraction (α) of this NO₂ absorbs into the solvent as NO₂⁻ while the rest directly reacts to form MNPZ. The NO₂⁻ then enters the stripper where it nitrosates PZ to form MNPZ and trace amounts of DNPZ with near perfect yield. The non-volatile NNO species and NO₂ will recycle back to the absorber where they pick up more NO₂ from the flue gas (FIG. 12). NO₂ in the flue gas is assumed to be the only nitrosating agent for nitrosamine formation, but nitrosating agents from PZ oxidation might become important precursors to nitrosamine formation if the flue gas is scrubbed of NO₂.

Equations 11-14 give overall mole balances across the stripper for NO₂⁻ and NNO with the stripper sump modeled as an ideal CSTR. NO₂⁻ approaches steady state in the first hour, so the NO₂⁻ time derivative is approximated as zero (Equation 8).

$$\begin{matrix}{\dot{n}}_{{NO}_{2}^{-} i} = {\dot{n}}_{{NO}_{2}^{-} f} + {y}_{{NO}_{2} {Flue}^{G}} & ( 11 ) \\ \frac{d {n}_{{NO}_{2}^{-}}}{d t} = {\dot{n}}_{{NO}_{2}^{-} i} - {\dot{n}}_{{NO}_{2}^{-} f} - {V}_{sump} {k}_{Form} {C}_{{NO}_{2}^{-} f} \approx 0 & ( 12 ) \\ {\dot{n}}_{NNOi} = {\dot{n}}_{NNOf} & ( 13 ) \\ \frac{d {n}_{NNO}}{d t} = {\dot{n}}_{NNOi} - {\dot{n}}_{NNOf} + ( {k}_{Form} {C}_{{NO}_{2}^{-} f} - {k}_{Decomp} {C}_{NNOf} ) & ( 14 )\end{matrix}$$

Dividing by the total volume of the amine scrubber and simplifying yields Equation 15.

$$\frac{d {C}_{NNO}}{d t} = \frac{{Y}_{{NO}_{2} Flue} G}{{V}_{tot}} - \frac{{V}_{sump}}{{V}_{tot}} {k}_{Decomp} {C}_{NNOf} \qquad ( 15 )$$

Solving gives the time-dependent and steady state NNO concentration, which is almost entirely MNPZ (Equations 16 & 17).

$$\begin{matrix}MNPZ ( t ) = {MNPZ}_{i} + ( {MNPZ}_{ss} - {MNPZ}_{i} ) [ 1 - {e}^{- {k}_{Decomp} \frac{{V}_{sump}}{{V}_{tot}} ⋃ t} ] & ( 16 ) \\ {MNPZ}_{ss} = \frac{{Y}_{{NO}_{2} Flue} G}{{k}_{Decomp} {V}_{sump}} = \frac{{Y}_{{NO}_{2} Flue} G}{{k}_{Decomp} {τ}_{sump}} * \frac{G}{L} & ( 17 )\end{matrix}$$

Formation of the NNO can be modelled as two parallel reactions to give the yield of DNPZ for a steady-state MNPZ concentration (Equation 18). Since the ratio of MNPZ to PZ is so low, the yield of DNPZ is expected to be very small.

$$\frac{{DNPZ}_{ss}}{{MNPZ}_{ss}} = \frac{{C}_{MNPZ} {k}_{FormDNPZ}}{{C}_{PZ} {k}_{FormMNPZ}} * \frac{{k}_{DecompMNPZ}}{{k}_{DecompDNPZ}} \qquad ( 18 )$$

Pilot Plant Comparison

A concentrated PZ solvent from a pilot plant running a real flue gas was sampled over an extended period of time and analyzed for MNPZ and DNPZ. FIG. 13 shows MNPZ concentration from the pilot plant along with the modeled MNPZ at conditions similar to the pilot plant conditions. MNPZ reached a steady state concentration between 1 mM and 2 mM. It takes on the order of 10 days for MNPZ to reach a new steady state concentration after a step change to the parameters. The steady state DNPZ will be on the order of 10⁻⁸M, which is undetectable using current methods.

Thus, the k_{g}′ is approximately 10⁻⁶ mol/Pa·m²·s for NO₂ absorption in 8 m PZ at 40° C. Over 90% of the NO₂ will absorb as NO₂⁻ or MNPZ. MNPZ formation from NO₂⁻ is first order in NO₂⁻, PZCOO⁻, and H⁺. MNPZ decomposition is first order in MNPZ and dependent on PZ and CO₂ loading. DNPZ formation is first order in NO₂⁻ and MNPZ. MNPZ formation will balance out with MNPZ thermal decomposition to yield a steady state MNPZ concentration that is on the order of 1 mM. Reaching the steady state concentration takes on the order of 10 days. The concentration of DNPZ is on the order of 10⁻⁵ mM, which is undetectable using current methods.

Formation and decomposition of nitroso-piperazine (NNO) compounds were studied under conditions pertinent to amine scrubbing. Nitrogen dioxide (NO₂) has an overall liquid-side mass transfer coefficient of approximately 10⁻⁶ mol/Pa·m²·s at 40° C. in 8 m PZ. In an amine scrubber designed to remove 90% CO₂, over 90% of the NO₂ will be absorbed as nitrite (NO₂) or n-nitrosopiperazine (MNPZ). The NO₂⁻ will travel to the absorber where it will react with PZ to form MNPZ and trace amounts of dinitrosopiperazine (DNPZ). NNO formation is first order in NO₂⁻, carbamated amine, and hydronium ions. The NNO will thermally decompose in the stripper. Thermal decomposition is first order in NNO and dependent on PZ concentration and loading. NNO formation from the flue gas NO₂ will balance out with NNO thermal decomposition to give steady state NNO concentrations. The NNO steady state concentration is proportional to the inlet NO₂. It is inversely proportional to the decomposition rate constant and the volume of the stripper sump. An amine scrubber using a flue gas without NOₓ removal will have a steady state MNPZ concentration on the order of 1 mM. Reaching the steady state concentration takes on the order of 10 days. DNPZ concentration will be on the order of 10⁻⁵ mM, which is undetectable using the methods in this work.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

### REFERENCES

Bottoms, R. R. Process for Separating Acidic Gases. U.S. Pat. No. 1,834,016, Oct. 15, 1930.
Rochelle, G. T. Amine Scrubbing for CO₂ Capture. Science. 2009, 325, 1652-4; DOI: 10.1126/science. 1176731.
Freeman, S. A; Dugas, R. E.; Van Wagener, D. H.; Nguyen, T.; Rochelle, G. T. Carbon dioxide capture with concentrated, aqueous piperazine. Int. J. Greenh. Gas Con. 2010, 4, 119-24; DOI: 10.1016/j.ijggc. 2009.10.008
Douglass, M. L. The chemistry of nitrosamine formation, inhibition and destruction. J. Soc. Cosmet. Chem. 1978, 29, (9), 581-606.
Lijinsky, W.; Conrad, E.; Van De Bogart, R. Carcinogenic Nitrosamines formed by Drug/Nitrite Interactions. Nature. 1972, 239, 165-67.
Mitch, William. Gassnova Website; http://www.gassnova.no/frontend/files/CONTENT/Rapporter/NitrosamineandNitramineformationchemistry_YALE.pdf.
Fine, N. A.; Goldman, M.; Nielsen, P. T.; Ashouripashaki, M.; Voice, A. K.; Rochelle, G. T. Managing N-nitrosopiperazine in Amine scrubbing. Presented at GHGT-11, Kyoto, Japan, Nov. 18-22, 2012. Energy Procedia 2013.
Goldman, M.; Fine, N.; Rochelle, G. T. Formation of N-Nitrosopiperazine and Dinitrosopiperazine in the CO₂ capture process. Manuscript in preparation. To be submitted to Env. Sci. and Tech., 2012.
Garcia, H.; Keefer, L.; Lijinsky, W.; Wenyon C. E. M. Carcinogenicity of nitrosothiomorpholine and 1-nitrosopiperazine in rats. Cancer Res. Clin. Oncol. 1970, 74, (2), 179-184; DOI: 10.1007/BF00525883.
Pai, S. R.; Shirke, A. J.; Gothoskar, S. V. Long-term feeding study in C17 mice administered saccharin coated betel nut and 1,4-dinitrosopiperazine in combination. Carcinogenesis. 1981, 2 (3), 175-77.
Norwegian Climate and Pollution Agency. Permit for activities pursuant to the Pollution Control Act. CO₂ Technology Centre Mongstad DA. 2011.
Tuazon, E. C.; Carter, W. P. L.; Atkinson, R.; Winer, A. M.; Pitts, J. N. Atmospheric reactions of N-nitrosodimethylamine and dimethylnitramine. Environ. Sci. Technol. 1984, 18 (1), 49-54; DOI: 10.1021/es00119a011.
Davie, M. G.; Shih, K.; Pacheco, F. A.; Leckie, J. O.; Reinhard, M. Palladium—Indium Catalyzed Reduction of N-Nitrosodimethylamine: Indium as a Promoter Metal. Environ. Sci. Technol. 2008, 42 (8), 3040-06.
Frierdich, A. J.; Shapley, J. R.; Strathmann, T. J. Rapid Reduction of N-Nitrosamine Disinfection Byproducts in Water with Hydrogen and Porous Nickel Catalysts. Environ. Sci. Technol. 2008, 42 (1), 262-9; DOI: 10.1021/es0712928.
Ashouripashaki, M. Formation and Decomposition of 1-Nitrosopiperazine in the CO₂ Capture Process. M. S. Thesis, The University of Texas Austin, Austin, Tex., 2012.
Freeman, S. A. Thermal Degradation and Oxidation of Aqueous piperazine for Carbon Dioxide Capture. Ph.D. Dissertation, The University of Texas Austin, Austin, Tex., 2011.
Chen, S. Nitrogen Dioxide Absorption in Aqueous Sodium Sulfite. Ph.D. Dissertation, The University of Texas Austin, Austin, Tex., 1997.
Mimura, T.; Shimojo, S.; Iijima, M.; Mitsuoka, S. Proccess for Removing Carbon Dioxide and Nitrogen Oxides from Combustion Gases. U.S. Pat. No. 5,648,053, Jul. 15, 1997.
Dai, N., Shah, A. D., Hu, L., Plewa, M. J., Mckague, B., & Mitch, W. A. (2012). Measurement of Nitrosamine and Nitramine Formation from NOx Reactions with Amines during Amine-Based Carbon Dioxide Capture for Postcombustion Carbon Sequestration. Environmental Science and Technology, 46, 9793-9801.
Challis, B. C.; Kyrtopoulos, S. A. Chemistry of Nitroso-Compounds. 11. Nitrosation of amines by the 2-phase interaction of amines in solution with gaseous oxides of nitrogen. J. Chem. Soc., Perkin Trans. 1 1979, 2, 299-304.
Mirvish, S. S. N nitroso compounds: Their chemical and in vivo formation and possible importance as environmental carcinogens. J. Toxicol. Environ. Health. 1977, 2, 1267-77.
Zhao, Y-L.; Garrison, S. L.; Marquez, M. N-Nitrosation of Amines by NO₂ and NO: A Theoretical Study. J. Phys. Chem. A. 2007, 111 (11), 2200-2205; DOI: 10.1021/jp0677703.
Casado, J.; Mosquera, M.; Paz, L. C.; Prieto, M. F. R.; Tato, J. V. Nitrite Ion as a Nitrosating Reagent. Nitrosation of Morpholine and Diethylamine in the Presence of Formaldehyde. J. Chem. Soc., Perkin Trans. 2. 1984, 12, 1963-66; DOI: 10.1039/P29840001963.
Sun, Z.; Liu, Y. D.; Zhong, R. G. Carbon Dioxide in the Nitrosation of Amine: Catalyst or Inhibitor? J. Phys. Chem. A. 2011, 115 (26), 7753-64; DOI: 10.1021/jp202002m.
Sexton, A. J.; Rochelle, G. T. Oxidation products of amines in CO₂ capture. Proceedings of Greenhouse Gas Technologies 8, Trondheim, Norway, 2006. pp 1-6.
Dugas, R. E. “Carbon Dioxide Absorption, Desorption, and Diffusion in Aqueous piperazine and Monoethanolamine.” Ph.D. Dissertation, The University of Texas Austin, Austin, Tex., 2009.
Nielsen, P. T.; Li L,; Rochelle G. T. piperazine degradation in pilot plants. Presented at GHGT-11, Kyoto, Japan, Nov. 18-22, 2012. Energy Procedia, 2013.

What is claimed is:

1. A method comprising:
contacting an acidic gas with an aqueous amine solvent in an absorber or a stripper, wherein the absorber or stripper operates at a lower steady-state concentration of nitrosamine.

2. The method of claim 1, wherein an additional volume of solvent is added to the absorber or stripper.

3. The method of claim 2, wherein the additional volume of solvent is added to the absorber or stripper at a temperature from about 90° C. to about 180° C.

4. The method of claim 2, wherein the additional volume of aqueous amine solvent is added at the bottom of the stripper or absorber.

5. The method of claim 2, wherein the additional volume of aqueous amine solvent is added to a lean stream of the stripper or absorber.

6. The method of claim 2, wherein the additional volume of aqueous amine solvent is added to a rich stream of the stripper or absorber.

7. The method of claim 1 wherein the aqueous amine solvent comprises at least one aqueous amine solvent selected from the group consisting of: piperazine; methyldiethanolamine; monoethanolamine; hydroxyethylpiperazine, 2-amino-2-methyl propanol, and 2-methylpiperazine.

8. The method of claim 1 wherein the aqueous amine solvent comprises at least one aqueous amine solvent that is more resistant to thermal degradation than methyldiethanolamine.

9. The method of claim 1 wherein the aqueous amine solvent comprises at least one aqueous amine solvent selected from the group consisting of: piperazine; hydroxyethylpiperazine; 2-methylpiperazine; 2-amino-2-methylpropanol; 1,6-diamino-hexane); 1,4-diamino-butane; Bis(aminoethyl)ether; and aminoethylpiperazine; and 2-piperidine ethanol.

10. A method comprising:
contacting an acidic gas with an aqueous amine solvent in an absorber;
flowing the solvent to a stripper;
extracting all or a portion of the solvent from the stripper and holding the extracted solvent at a temperature greater than the operating temperature of the stripper for a period of time sufficient to thermally decompose nitrosamine present in the extracted solvent.

11. The method of claim 10 wherein the aqueous amine solvent comprises at least one aqueous amine solvent selected from the group consisting of: piperazine; methyldiethanolamine; monoethanolamine; hydroxyethylpiperazine, 2-amino-2-methyl propanol, and 2-methylpiperazine.

12. The method of claim 10 wherein the extracted solvent is held at a temperature in the range of from about 160° C. to about 180° C.

13. The method of claim 10 wherein the aqueous amine solvent comprises at least one aqueous amine solvent selected from the group consisting of: piperazine; hydroxyethylpiperazine; 2-methylpiperazine; 2-amino-2-methylpropanol; 1,6-diamino-hexane); 1,4-diamino-butane; Bis(aminoethyl)ether; and aminoethylpiperazine; and 2-piperidine ethanol.

14. The method of claim 10 further comprising flowing the extracted solvent through a cross-exchanger to return the extracted solvent to the stripper.

15. The method of claim 10 further comprising recirculating the solvent from the stripper to the absorber.

16. The method of claim 10 wherein the nitrosamine is n-nitrosopiperazine, dinitrosopiperazine, or a combination thereof.

17. The method of claim 10 wherein the acidic gas comprises CO₂.

18. The method of claim 10, wherein the stripper is operating at a temperature in the range of from about 140° C. to about 150° C.

19. The method of claim 10, wherein the aqueous amine solvent comprises at least one aqueous amine solvent that is more resistant to thermal degradation than methyldiethanolamine.
